(19) United States
(12) Patent Application Publication
(10) Pub. No.: US 2026/0012547 A1
(43) Pub. Date: Jan. 8, 2026

(54) IMAGE PROCESSING APPARATUS, CONTROL METHOD, AND STORAGE MEDIUM

(71) Applicant: CANON KABUSHIKI KAISHA, Tokyo (JP)

(72) Inventor: NOBUYUKI TSUKADA, Saitama (JP)

(21) Appl. No.: 19/249,692

(22) Filed: Jun. 25, 2025

(30) Foreign Application Priority Data
Jul. 3, 2024 (JP) 2024-107514

(51) Int. Cl. H04N 1/00

(52) U.S. Cl. CPC H04N 1/00809; H04N 1/00413; H04N 1/00482; H04N 1/00824; H04N 2201/0094

(57) ABSTRACT

An image processing apparatus includes a reading unit configured to execute a reading process for reading a document placed on a document platen, a printing unit configured to print image data obtained by the reading unit executing the reading process, and a control unit configured to execute a control process for performing control so that an orientation of first image data generated by the reading unit executing the reading process on the first document relative to a sheet discharge direction of a first sheet on which the first image data is printed by the printing unit, and an orientation of second image data generated by the reading unit executing the reading process on the second document relative to a sheet discharge direction of a second sheet on which the second image data is printed by the printing unit are similar orientations.

### BACKGROUND

### Field of the Technology

The present disclosure relates to an image processing apparatus, a control method, and a storage medium.

### Description of the Related Art

An image processing apparatus having the function of reading a document placed on a document platen is known. Japanese Patent Application Laid-Open No. 2009-100099 discusses a technique for reading a document larger than a document platen of an image reading apparatus in two parts, distinguishing the directions of images based on character information regarding respective pieces of image data of the read document, automatically distinguishing the orientation of the document and placement information regarding the pieces of image data in the document based on the directions of the images and document abutment reference position information regarding the document platen, and combining the two pieces of image data.

However, for example, Japanese Patent Application Laid-Open No. 2009-100099 does not discuss the printing of the pieces of image data taking into account the orientations of the pieces of image data relative to the sheet discharge directions in which sheets on which the pieces of image data are printed are to be discharged.

### SUMMARY

According to an aspect of the present disclosure, an image processing apparatus includes a reading unit configured to execute a reading process for reading a document placed on a document platen, a printing unit configured to print image data obtained by the reading unit executing the reading process, a display control unit configured to display a screen indicating a method for placing a first document on the document platen, and a screen indicating a method for placing a second document on the document platen and for placing the second document on the document platen in an orientation different from an orientation in which the first document is placed on the document platen, and a control unit configured to execute a control process for performing control so that an orientation of first image data generated by the reading unit executing the reading process on the first document relative to a sheet discharge direction of a first sheet on which the first image data is printed by the printing unit, and an orientation of second image data generated by the reading unit executing the reading process on the second document relative to a sheet discharge direction of a second sheet on which the second image data is printed by the printing unit are similar orientations.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram of a multifunction peripheral (MFP).

FIG. 2 is an external view of an operation display unit and a liquid crystal display (LCD).

FIGS. 3A and 3B are diagrams illustrating a standard home screen and a custom home screen displayed on the operation display unit.

FIGS. 4A and 4B are external views of the MFP.

FIGS. 5A and 5B are external views illustrating a setting position of a sheet and a sheet discharge position of a sheet in the MFP.

FIGS. 6A and 6B are external views illustrating a method for setting a booklet document.

FIG. 7 is a diagram illustrating a booklet document and printing results after copying.

FIGS. 8A and 8B are external views illustrating a method for setting a booklet document.

FIG. 9 is a diagram illustrating a booklet document and printing results after copying.

FIG. 10 is a flowchart illustrating a booklet copying selection operation according to one or more aspects of the present disclosure.

FIG. 11 is a diagram illustrating transition of screens in the booklet copying selection operation according to one or more aspects of the present disclosure.

FIG. 12 is a flowchart illustrating a booklet copying control process according to one or more aspects of the present disclosure.

FIG. 13 is a diagram illustrating transition of screens in the booklet copying control process according to one or more aspects of the present disclosure.

FIG. 14 is a flowchart illustrating a booklet copying execution process according to one or more aspects of the present disclosure.

FIG. 15 is a flowchart illustrating a booklet copying two-sided printing setting method according to one or more aspects of the present disclosure.

FIG. 16 is a diagram illustrating transition of screens in the booklet copying two-sided printing setting method according to one or more aspects of the present disclosure.

FIG. 17 is a diagram illustrating a booklet document and printing results after copying according to one or more aspects of the present disclosure.

FIG. 18 is a flowchart illustrating a document binding setting process and a first document setting guide screen display switching process according to one or more aspects of the present disclosure.

FIG. 19 is a diagram illustrating a first document setting guide screen based on a document binding setting value according to one or more aspects of the present disclosure.

FIG. 20 is a flowchart illustrating a booklet copying main screen display switching process according to one or more aspects of the present disclosure.

FIG. 21 is a diagram illustrating a booklet copying main screen based on the document binding setting value according to one or more aspects of the present disclosure.

FIG. 22 is a flowchart illustrating a second document setting guide screen display switching sequence according to one or more aspects of the present disclosure.

FIG. 23 is a diagram illustrating a second document setting guide screen based on the document binding setting value according to one or more aspects of the present disclosure.

### DESCRIPTION OF THE EMBODIMENTS

The present disclosure will be described in detail below with reference to the drawings. The following exemplary embodiments do not limit the present disclosure according to the appended claims, and not all the combinations of the features described in the exemplary embodiments are essential for a method for solving the issues in the present disclosure. In the attached drawings, the same or similar components are designated by the same reference numbers, and are not redundantly described.

### <Block Diagram>

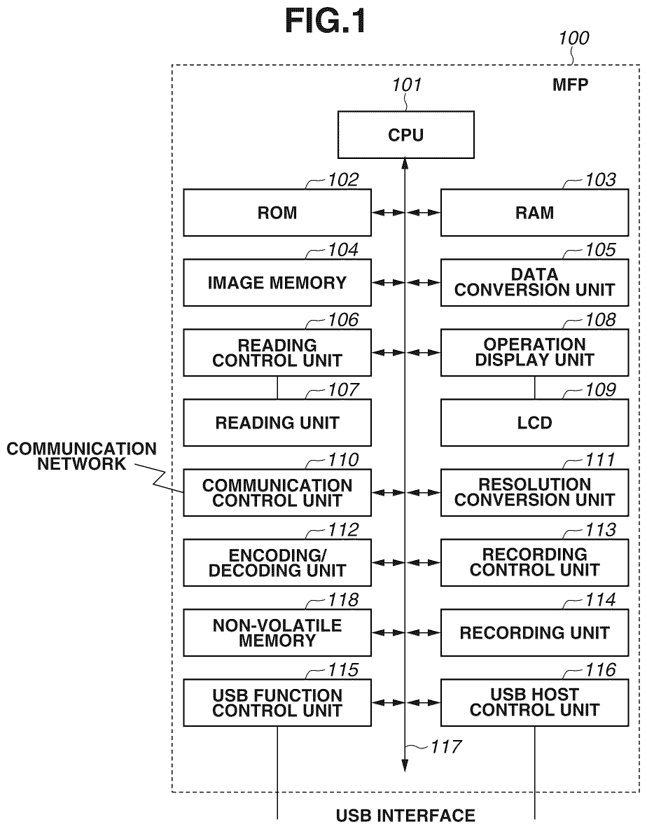

FIG. 1 is a block diagram illustrating an example of the general configuration of a multifunction peripheral (MFP) 100 as an example of an image processing apparatus according to a first exemplary embodiment. The MFP 100 is a type of information processing apparatus. The MFP 100 is also a type of electronic device.

The MFP 100 according to the present exemplary embodiment has information processing functions for generating, storing, and transmitting device information including log information and status information. The MFP 100 also has an image forming (printing) function for forming an image on a recording medium (a sheet) using a recording control unit 113 and a recording unit 114. The image processing apparatus may be a single-function printer (SFP), or may be a personal computer (PC), a terminal apparatus, a smartphone, or a digital camera, instead of the MFP 100. The printing method of the image processing apparatus according to the present exemplary embodiment may be an inkjet method or an electrophotographic method, or may be another method.

The MFP 100 includes a central processing unit (CPU) 101, a read-only memory (ROM) 102, a random-access memory (RAM) 103, an image memory 104, a data conversion unit 105, a reading control unit 106, a reading unit 107, an operation display unit 108, a liquid crystal display (LCD) 109, a communication control unit 110, and a resolution conversion unit 111. The MFP 100 also includes an encoding/decoding unit 112, a recording control unit 113, a recording unit 114, a Universal Serial Bus (USB) function control unit 115, a USB host control unit 116, a bus 117, and a non-volatile memory 118.

The CPU 101 is a system control unit and controls the entirety of the MFP 100. The ROM 102 is a non-volatile memory that stores fixed data such as control programs to be executed by the CPU 101, a data table, and an embedded operating system (OS). In the present exemplary embodiment, the control programs stored in the ROM 102 control the execution of software such as scheduling, a task switch, and interrupt processing under control of the embedded OS stored in the ROM 102. The ROM 102 stores information indicating a permission state regarding whether to provide device information to outside. The RAM 103 is composed of a static random-access memory (SRAM), which requires a backup power supply. A primary battery for data backup (not illustrated) guarantees the feeding of power to the RAM 103. The RAM 103 stores a program control variable. The image memory 104 is composed of a dynamic random-access memory (DRAM) and can accumulate image data. A partial area of the image memory 104 is allocated as a work area for executing software processing. The data conversion unit 105 can analyze a page description language (PDL) or convert image data by expanding character data into computer graphics (CG).

The reading unit 107 optically reads a document using a contact image sensor (CIS) and converts the read document into an electrical image signal. The reading control unit 106 performs various types of image processing such as a binarization process or a halftone process on the image signal and outputs high-definition image data. The technique for optically reading a document may be either a sheet reading control method for reading a document using a fixed CIS or a book reading control method for reading a document fixed on a document platen using a moving CIS.

The operation display unit 108 is composed of buttons such as a home button, a return button, a start button, and a stop button and a light-emitting diode (LED). The LCD 109 displays various pieces of information to a user through a screen and also further has a touch sensing function for detecting a touch operation of the user on the screen.

The communication control unit 110 controls communication between the MFP 100 and a communication network. The communication control unit 110 connects to an Internet service provider or communicates various pieces of data between the MFP 100 and a service management server 200. The communication control unit 110 can also determine whether the MFP 100 is connected to the Internet or connected to only a local area network (LAN). The connection between the communication control unit 110 and the communication network is made using a known method such as Hypertext Transfer Protocol (HTTP) or Extensible Messaging and Presence Protocol (XMPP). The resolution conversion unit 111 performs a resolution conversion process for converting millimeter image data and inch image data into each other. The resolution conversion unit 111 can also execute an enlargement/reduction process on image data.

The encoding/decoding unit 112 performs an encoding/coding process or performs an enlargement/reduction process on image data (uncompressed, Modified Huffman (MH), Modified READ (MR), Modified Modified READ (MMR), Joint Bi-level Image Experts Group (JBIG), or Joint Photographic Experts Group (JPEG)) handled by the MFP 100. The recording control unit 113 performs various types of image processing such as a smoothing process, a recording density correction process, or color correction on image data to be printed, thereby converting the image data into high-definition image data. Then, the recording control unit 113 outputs the high-definition image data to the recording unit 114. The recording control unit 113 also functions to periodically acquire state information data of the recording unit 114. The recording unit 114 is composed of a laser beam printer or an inkjet printer and prints image data generated by the recording control unit 113 on a recording medium such as a sheet. The recording unit 114 also has a two-sided printing function for performing printing on both sides of a recording medium.

The USB function control unit 115 performs protocol control according to the USB communication standard. The USB host control unit 116 is a control unit for performing communication using a protocol defined by the USB communication standard. The USB communication standard is a standard for two-way high-speed data communication. The USB communication standard defines that a plurality of hubs or functions (slaves) can be connected to a single host (master). That is, the USB host control unit 116 provides the function of a host in USB communication. For example, a recording device such as a USB memory is connected to the USB host control unit 116, and the USB host control unit 116 reads and writes data from and to the recording device. The components other than the reading unit 107 and the LCD 109 are connected to each other via the bus 117.

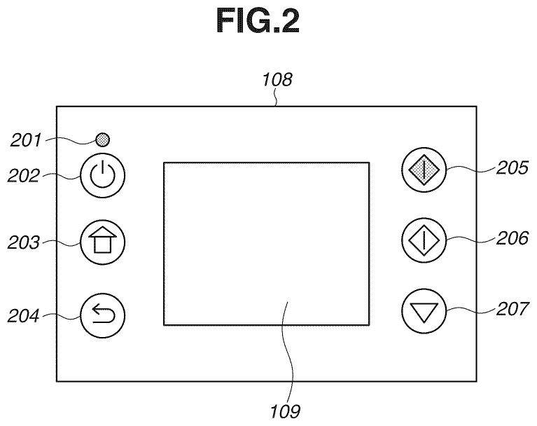

FIG. 2 is an external view illustrating the operation display unit 108 and the LCD 109. The operation display unit 108 includes an LED 201 that lights up when the power supply of the MFP 100 is in an on state, and a power button (software button) 202 for switching the turning on and off (a software-on state and a software-off state) of the power supply of the apparatus. The operation display unit 108 also includes a home button 203 for displaying a home screen, and a return button 204 for returning a display screen to the previous state. Further, the operation display unit 108 includes a color start button 205 for executing color copying or color scanning, a monochrome start button 206 for executing monochrome copying or monochrome scanning, and a stop button 207 for stopping a printing or scanning operation of the apparatus. The buttons 202 to 207 are provided in a housing of the MFP 100, but may be software buttons displayed on the LCD 109. The LCD 109 can display at least characters indicating information regarding the MFP 100, using a display control method.

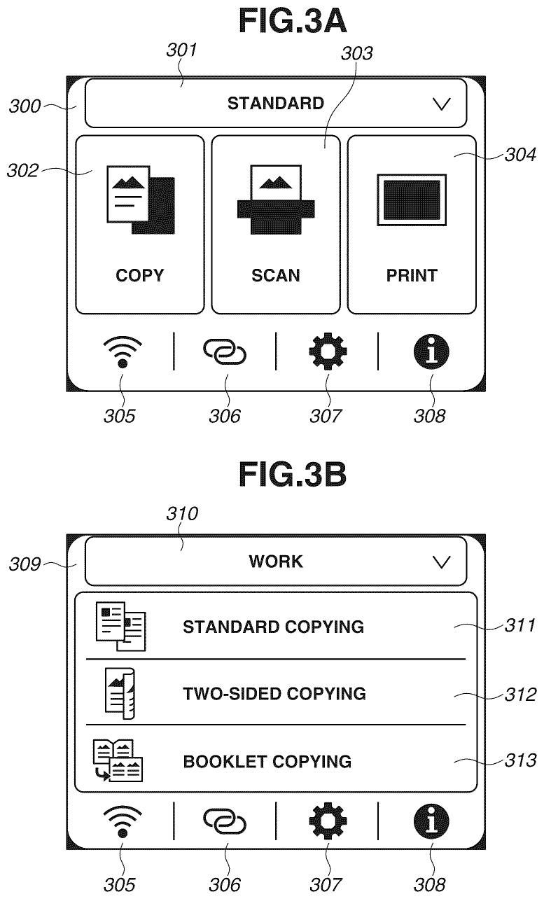

FIG. 3A is a diagram illustrating display content of a home screen displayed on the operation display unit 108 in a case where the MFP 100 is started. A home screen 300 in FIG. 3A illustrates the entirety of a standard home screen. An area 301 is a home screen switching button for switching home screens and displays “standard” indicating that the currently selected home screen is the standard home screen.

The standard home screen 300 displays a copy menu button 302 for executing a copy function, a scan menu button 303 for executing a scan function, and a print menu button 304 for executing a print function in a middle portion. A LAN button 305, a wireless connect button 306, a settings button 307, and a hint button 308 exist in a lower portion. Then, each button is operated by the user, whereby the standard home screen 300 transitions to a screen corresponding to the button. For example, if the copy menu button 302 is selected, a settings area (screen) where the setting values of the copy function can be set, or an area (a screen) for giving an instruction to start the execution of the copy function is displayed. Then, the color start button 205 in FIG. 2 is pressed by the user on the screen displayed by selecting the copy menu button 302, whereby the execution of color copying is started. Or the monochrome start button 206 is pressed by the user on the screen displayed by selecting the copy menu button 302, whereby the execution of monochrome copying is started.

In the present exemplary embodiment, home screens include three custom home screens in addition to the standard home screen and are configured to allow the user to select any home screen.

A home screen 309 in FIG. 3B illustrates display content of a “work” home screen that is one of the custom home screens. An area 310 in an upper portion illustrates a home screen switching button and displays “work” indicating the current home screen. Buttons 311 to 313 in a middle portion illustrate custom buttons (functions) that can be freely registered by the user. An example is illustrated where “standard copying” is registered in the button 311, “two-sided copying” is registered in the button 312, and a “booklet copying” function is registered in the button 313. The booklet copying function refers to a copy function used to execute a copy function for copying a document bound in the form of a booklet. If each custom button is selected, the home screen 309 can transition to a settings area where the setting values of the registered function can be set, or an area for giving an instruction to start the execution of the registered function. Buttons 305 to 308 in a lower portion illustrate buttons having the same contents as those on the standard home screen 300.

As the custom home screens, home screens corresponding to the use purposes of the MFP 100, such as a “learning” home screen and a “life” home screen in addition to the “work” home screen, can be displayed. As the names of the custom home screens, “work”, “learning”, and “life” are set before shipment from the factory. The settings button 307 for opening a settings screen where the MFP 100 can be set is operated, and the names of the custom home screens can be changed on a screen for changing the names of the custom home screens. The menu buttons displayed on the standard home screen are not buttons specified and registered by the user, but buttons registered in advance before shipment from the factory. On the other hand, the menu buttons displayed on each custom home screen are buttons specified and registered by the user.

Specifically, the settings button 307 displayed on the standard home screen or each custom home screen is selected, and menu buttons selected by the user in a setting for registering menus on the custom home screen are displayed in menus on the custom home screen.

For example, the user selects the settings button 307 on the “work” home screen and selects a currently registered “save document in personal computer” button in a setting for registering menus on the “work” home screen. Subsequently, if the user selects “booklet copying” that the user wishes to display in place of “save document in personal computer”, “booklet copying” is displayed at the position where “save document in personal computer” has been displayed on the “work” home screen. On the “work” home screen, the initial values of the custom home screens before shipment from the factory are three functions, namely “standard copying”, “two-sided copying”, and “save document in personal computer” from the top. On the “learning” home screen, the initial values of the custom home screens before shipment from the factory are three functions, namely “two-sided copying”, “fixed form printing”, and “printing from cloud” from the top.

On the “life” home screen, the initial values of the custom home screens before shipment from the factory are three functions, namely “pattern paper printing”, “fixed form printing”, and “printing from cloud” from the top.

In the switching of home screens, a home screen can be selected on a home selection screen displayed by operating the home screen switching button 301 in FIG. 3A in the example of the standard home screen or the home screen switching button 310 illustrated in FIG. 3B in the example of the “work” home screen. If a home screen is selected, information regarding the home screen is saved (stored) in the non-volatile memory 118 such that the home screen is a currently enabled home screen. Even if each home screen transitions to a screen other than the home screen, the currently enabled home screen is not changed.

Further, the determination of which of the standard home screen and the custom home screens is to be displayed in a case where the MFP 100 is started is made based on a screen displayed before the power supply of the MFP 100 transitions to the off state. Specifically, if the power supply of the MFP 100 transitions to the off state in the state where the standard home screen is displayed on the LCD 109 of the MFP 100, and then, the power supply of the MFP 100 transitions to the on state, the standard home screen is displayed on the LCD 109 based on the fact that a home screen displayed when the power supply of the MFP 100 transitions to the off state is the standard home screen. For example, if the power supply of the MFP 100 transitions to the off state in the state where the “work” home screen is displayed on the LCD 109 of the MFP 100, and then, the power supply of the MFP 100 transitions to the on state, the “work” home screen is displayed on the LCD 109 based on the fact that a home screen displayed when the power supply of the MFP 100 transitions to the off state is the “work” home screen. That is, if the MFP 100 detects that home screens to be displayed on the LCD 109 are switched, the MFP 100 saves (stores) information regarding the home screen after the switching in the non-volatile memory 118 such that the home screen is the currently enabled home screen. Then, the home screen after the switching is displayed based on the saved information. The case where the power supply of the MFP 100 transitions to the on state or the off state is a case where the power button 202 is pressed. Alternatively, the case where the power supply of the MFP 100 transitions to the on state or the off state may be a case where power is supplied to the MFP 100.

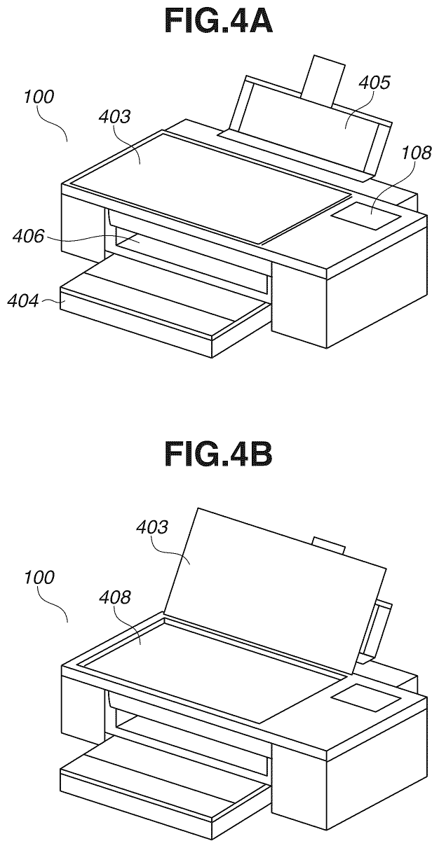

FIGS. 4A and 4B are external views of the MFP 100. FIG. 4A is a diagram illustrating the MFP 100 in the state where a document platen cover 403 is closed. FIG. 4B is a diagram illustrating the MFP 100 in the state where the document platen cover 403 is opened.

FIG. 4A illustrates the MFP 100, the operation display unit 108, and a document platen cover 403 for a document platen on which a document is set.

FIG. 4A also illustrates the MFP 100 including a sheet feeding cassette 404 that is a first sheet feeding port in which a sheet is placed (set), a sheet feeding tray 405 that is a second sheet feeding port in which a sheet is placed (set), and a sheet discharge port 406 to which a sheet on which a printing process is executed (image data is printed) is discharged.

FIG. 4B illustrates the MFP 100 including a document platen 408 on which a document is placed in a case where the document is read using the reading unit 107 (a scanner). The reading unit 107 is built in below the document platen 408.

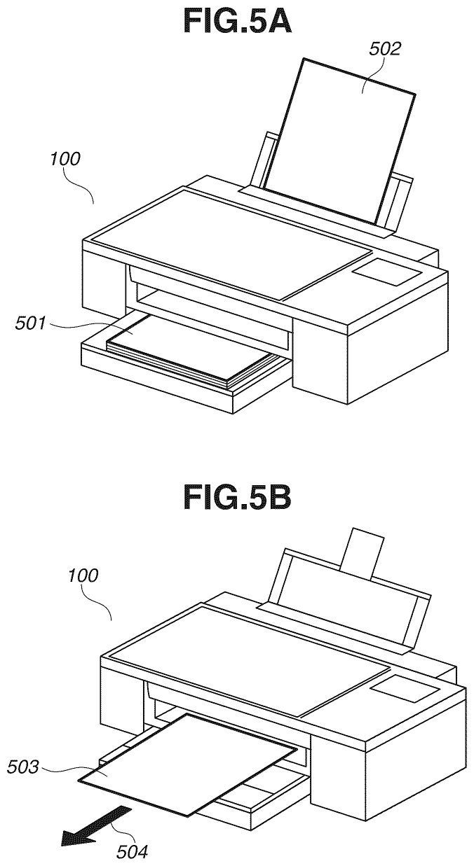

FIGS. 5A and 5B are diagrams illustrating the position where a sheet on which image data of a document (written document data or recording data) is to be printed by executing a printing process is set, and the sheet discharge position and the sheet discharge direction of a sheet subjected to printing in the MFP 100.

FIG. 5A illustrates a sheet 501 set in the sheet feeding cassette (404 in FIG. 4) that is the first sheet feeding port, and a sheet 502 set in the sheet feeding tray (405 in FIG. 4). Either the sheet 501 or the sheet 502 is pulled into the MFP 100, whereby a printing process is executed on the pulled sheet.

FIG. 5B illustrates a sheet 503 subjected to a printing process and discharged, and an arrow 504 indicating the direction in which the sheet 503 is discharged. That is, the sheet 503 subjected to the printing process is discharged in the direction (the orientation) of the arrow 504.

In a case where a document bound in the form of a booklet is read by the reading unit 107 and duplicated (the copy function is executed), there is a possibility that a method for setting each side (one side) of the booklet document in a double-page spread state on the document platen 408 and reading an image is performed.

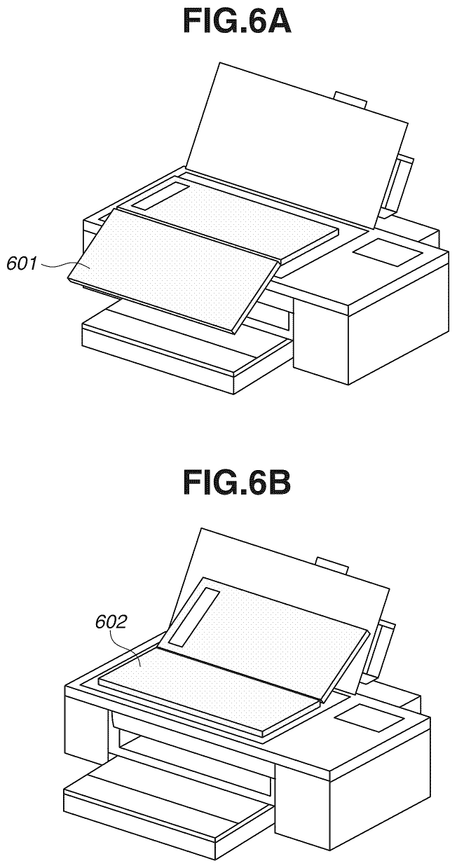

FIGS. 6A and 6B are diagrams illustrating a method for setting each side of a booklet document in a double-page spread state on the document platen 408. FIG. 6A illustrates a document 601 in the state where a booklet document is set on the document platen 408 with a left page of the booklet document in a double-page spread state face down. FIG. 6B illustrates a document 602 in the state where the same booklet document is set on the document platen 408 with a right page of the booklet document face down.

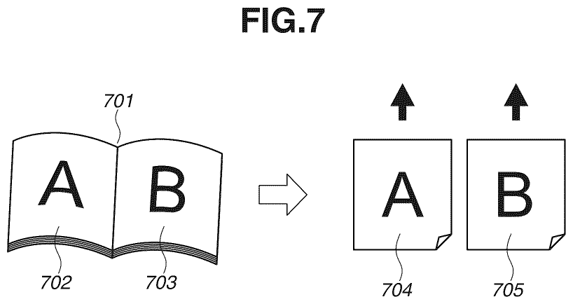

FIG. 7 is a diagram illustrating printing results in a case where a booklet document is set as illustrated in FIGS. 6A and 6B and the copy function is executed. FIG. 7 illustrates a booklet document 701 in a double-page spread state, image data “A” of a left page 702 in printing target pages of the booklet document 701, and image data “B” of a right page 703 in the printing target pages of the booklet document 701. FIG. 7 also illustrates a printing result 704 in a case where the left page 702 of the document 701 is set on the document platen 408 as illustrated in FIG. 6A and the copy function is executed, and it is indicated that a sheet is discharged in the orientation of an arrow. Similarly, FIG. 7 illustrates a printing result 705 in a case where the right page 703 of the document 701 is set on the document platen 408 as illustrated in FIG. 6B and the copy function is executed, and it is indicated that a sheet is discharged in the orientation of an arrow. Thus, a booklet document is set as illustrated in FIGS. 6A and 6B, whereby a plurality of sheets is discharged such that pieces of image data as printing results of a right page and a left page of the document are in similar directions (the same direction). However, to set the booklet document as illustrated in FIG. 6B, a page on the side where reading is not performed (the left page in FIG. 6B) interferes with the document platen cover 403 of the MFP 100. Thus, there is a possibility that an issue arises where the document cannot be set at an appropriate position on the document platen 408.

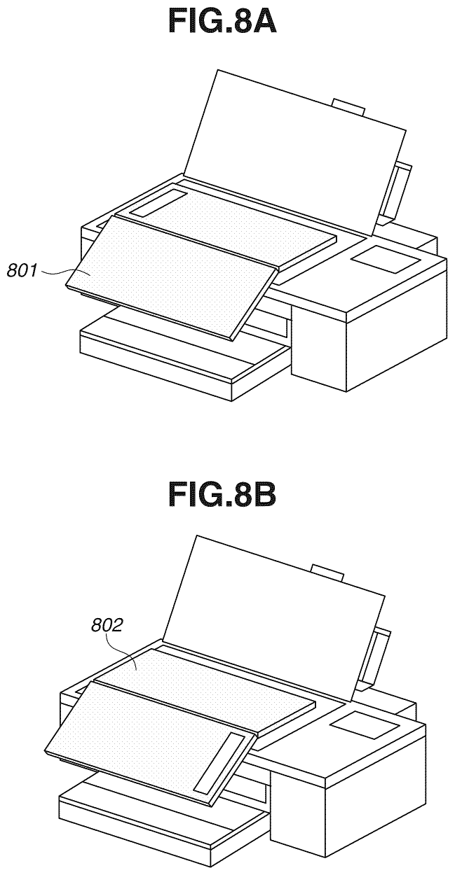

FIGS. 8A and 8B are diagrams illustrating a method for setting a document to solve the above issue. FIG. 8A is a diagram illustrating a document 801 in the state where a left page of a booklet document is set on the document platen 408, and is similar to FIG. 6A. On the other hand, FIG. 8B is a diagram illustrating a document 802 in the state where a right page of the document is set on the document platen 408 by rotating the booklet document by 180 degrees in a horizontal direction relative to the orientation of the booklet document set on the document platen 408 in FIG. 8A. The booklet document is set on the document platen 408 as illustrated in FIG. 8B, whereby a page on the side where a reading process is not to be executed (the left page in FIG. 8B) does not interfere with the document platen cover 403 of the MFP 100. This reduces an inability to set the document at an appropriate position on the document platen 408.

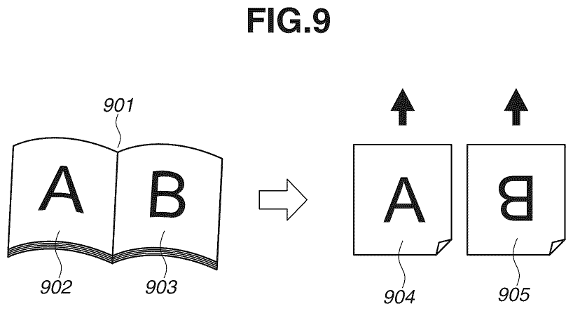

FIG. 9 is a diagram illustrating results in a case where a booklet document is set as illustrated in FIGS. 8A and 8B and the copy function is executed. FIG. 9 illustrates a booklet document 901 in a double-page spread state, image data “A” of a left page 902 in printing target pages of the booklet document 901, and image data “B” of a right page 903 in the printing target pages of the booklet document 901. FIG. 9 also illustrates a printing result 904 in a case where the left page 902 of the document 901 is set on the document platen 408 as illustrated in FIG. 8A and the copy function is executed, and it is indicated that a sheet is discharged in the orientation of an arrow. Similarly, FIG. 9 illustrates a printing result 905 in a case where the right page 903 of the document 901 is set on the document platen 408 as illustrated in FIG. 8B and the copy function is executed, and it is indicated that a sheet is discharged in the orientation of an arrow. Thus, a booklet document is set as illustrated in FIGS. 8A and 8B, whereby the orientation of image data “A” of a left page of the document relative to the sheet discharge direction of a sheet on which the image data “A” is printed, and the orientation of image data “B” of a right page of the document relative to the sheet discharge direction of a sheet on which the image data “B” is printed are different from each other. That is, in a case where a booklet document is set on the document platen 408 as illustrated in FIGS. 8A and 8B and the copy function is executed, pieces of image data on a plurality of sheets as the results of printing left and right pages in printing target pages are discharged in different orientations. Thus, the work of aligning the orientations of the plurality of sheets as the printing results occurs to the user, and usability decreases.

Accordingly, in a case where the copy function is executed on left and right pages of a booklet document as printing targets, the MFP 100 according to the present exemplary embodiment executes a control process for performing control so that the orientation of image data of the left page relative to the sheet discharge direction in a case where a sheet on which the left page is printed is discharged and the orientation of image data of the right page relative to the sheet discharge direction of a sheet on which the right page is printed are similar orientations. Further, the MFP 100 according to the present exemplary embodiment displays a method for indicating the placement of the respective pages of the booklet document on the document platen 408 (in which orientation the document is to be placed relative to the document platen 408) according to the control process.

Consequently, it is possible to reduce a decrease in usability due to the occurrence of the work of aligning the orientations of a plurality of sheets as printing results. Further, in a case where a page on the side where a reading process is to be executed is set on the document platen 408, a page on the side where the reading process is not to be executed does not interfere with the document platen cover 403 of the MFP 100. This reduces an inability to set the document at an appropriate position on the document platen 408.

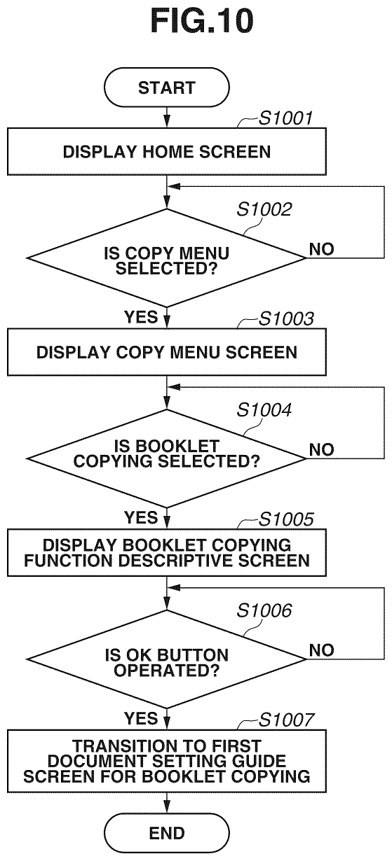

FIG. 10 is a flowchart illustrating a method for selecting the “booklet copying function” that is a function to which the above control is applied. A series of processes illustrated in this flowchart is executed by the CPU 101 of the MFP 100 loading program code stored in the ROM 102 into the RAM 103. The processing of this flowchart is started based on the state where the standard home screen is displayed (the state corresponding to step S1001).

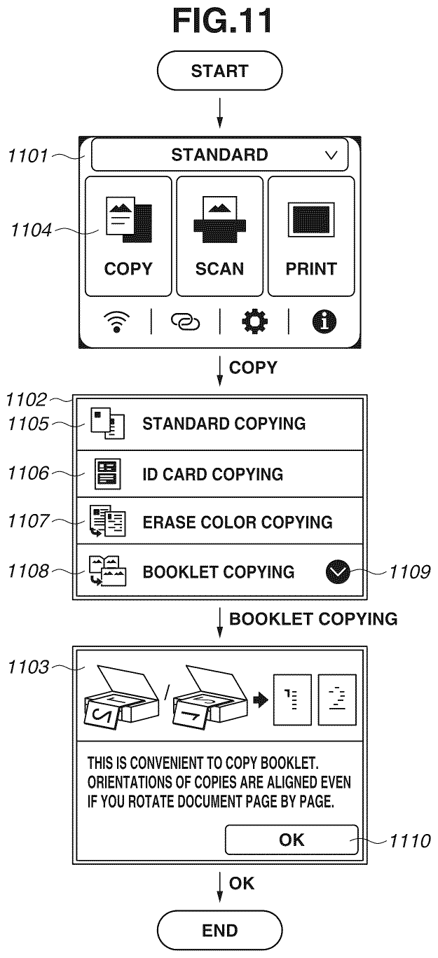

FIG. 11 is a diagram illustrating the method for selecting the booklet copying function. A screen 1101 illustrates a standard home screen. A button 1104 illustrates a copy menu button. A screen 1102 illustrates a copy menu screen that is a selection screen where the type of a copy function can be selected. Buttons 1105 to 1108 are buttons indicating the types of copy functions. The button 1105 illustrates a button indicating a standard copying function. The button 1106 illustrates a button indicating an identification (ID) card copying function. The button 1107 illustrates a button indicating an erase color copying function. The button 1108 illustrates a button indicating the booklet copying function. A button 1109 is a button for scrolling the screen. If the CPU 101 detects an operation on the button 1109, the CPU 101 executes a scrolling process on the screen and displays a button indicating the type of another copy function that has not been displayed on the screen before the scrolling process. A screen 1103 is a descriptive screen that displays the description of the booklet copying function. An illustration and descriptive text indicate that the orientations of pieces of image data relative to the sheet discharge directions of sheets are aligned by executing the copy function using the booklet copying function. A button 1110 illustrates an OK button for ending the display on the screen 1103.

Next, with reference to FIGS. 10 and 11, the method for selecting the booklet copying function is described.

The flowchart in FIG. 10 is started based on the transition of the power supply of the MFP 100 to the on state in the state where information regarding a currently enabled home screen held in the non-volatile memory 118 of the MFP 100 indicates the standard home screen. Alternatively, the flowchart in FIG. 10 is started based on an operation on the home button 203 in the state where a screen other than the standard home screen is displayed by performing a predetermined operation on the standard home screen.

First, in step S1001, the CPU 101 displays the standard home screen 1101 in FIG. 11.

Next, in step S1002, the CPU 101 determines whether an operation of selecting the copy menu button 1104 in FIG. 11 is performed. If it is determined that the operation of selecting the copy menu button 1104 is performed (YES in step S1002), the processing proceeds to step S1003. If it is determined that the operation of selecting the copy menu button 1104 is not performed (NO in step S1002), the CPU 101 repeats the process of step S1002.

In step S1003, the CPU 101 displays the copy menu screen 1102 in FIG. 11.

Next, in step S1004, the CPU 101 determines whether an operation of selecting the booklet copying function button 1108 in FIG. 11 is performed. If it is determined that the operation of selecting the booklet copying function button 1108 is performed (YES in step S1004), the processing proceeds to step S1005. If it is determined that the operation of selecting the booklet copying function button 1108 is not performed (NO in step S1004), the CPU 101 repeats the process of step S1004.

In step S1005, the CPU 101 displays the booklet copying function descriptive screen 1103 in FIG. 11.

Next, in step S1006, the CPU 101 determines whether an operation of selecting the OK button 1110 in FIG. 11 is performed. If it is determined that the operation of selecting the OK button 1110 is performed (YES in step S1006), the processing proceeds to step S1007. If it is determined that the operation of selecting the OK button 1110 is not performed (NO in step S1006), the CPU 101 repeats the process of step S1006. Although described below, if it is determined that the OK button 1110 is selected, then in step S1007, a first document setting guide screen is displayed. The first document setting guide screen refers to a screen indicating a method for, in a double-page spread document to be subjected to a reading process in a booklet document, setting a first document (a first half surface) to be subjected to the reading process before a second document (a second half surface) to be subjected to the reading process.

A description has been given of a procedure where the booklet copying function is selected by operating the copy menu button 302 on the standard home screen 300 in FIG. 3A. Also, in a case where the button 313 in which the booklet copying function is registered is selected on the custom home screen 309 in FIG. 3B, the custom home screen 309 can transition to the first document setting guide screen for the booklet copying function. In this case, the flowchart in FIG. 10 is started based on the state where a custom home screen displayed in a case where the power supply of the MFP 100 transitions to the off state is displayed in a case where the power supply of the MFP 100 transitions to the on state. Alternatively, the flowchart in FIG. 10 is started based on an operation on the home button 203 in the state where a screen other than any predetermined custom home screen among the custom home screens is displayed by performing a predetermined operation on the predetermined custom home screen.

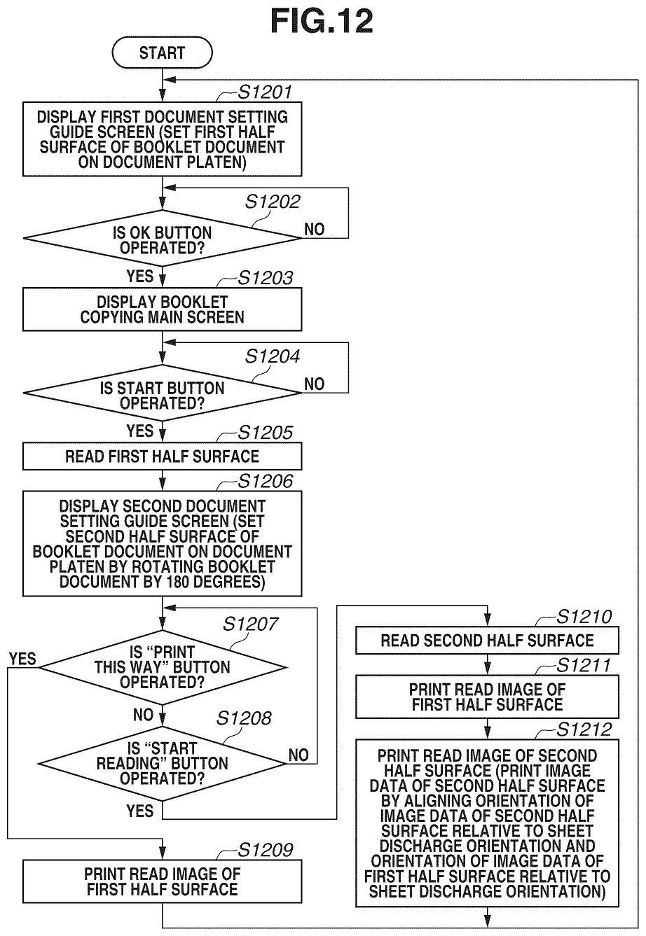

FIG. 12 is a flowchart illustrating a control process for controlling the booklet copying function according to the present exemplary embodiment.

The processing of this flowchart is started based on the detection of the operation on the OK button 1110 in step S1006 in FIG. 10.

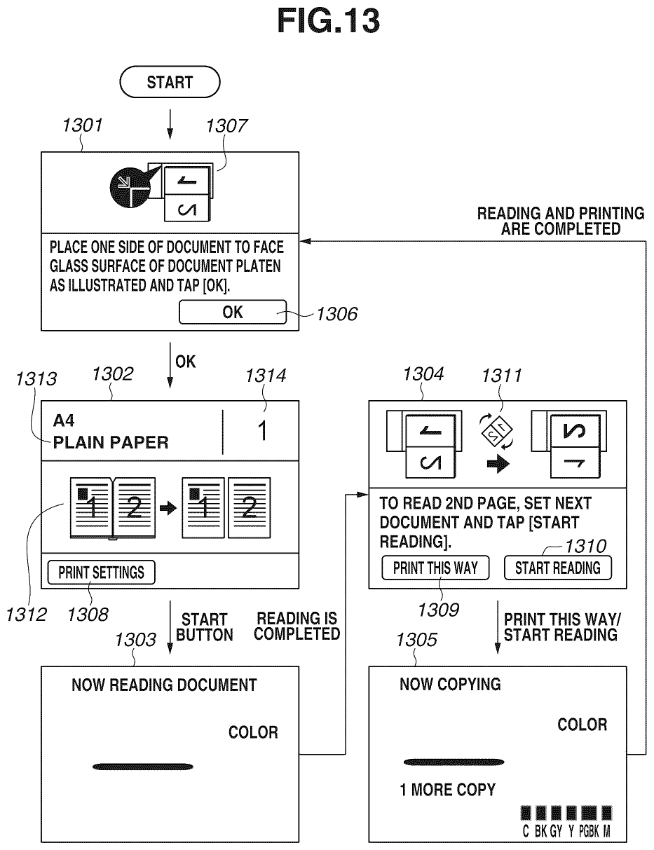

FIG. 13 is a diagram illustrating the transition of screens displayed in the control process for controlling the booklet copying function.

A screen 1301 illustrates the first document setting guide screen and includes an illustration 1307 indicating a setting method and an OK button 1306. Based on an operation on the OK button 1306, a screen 1302 is displayed.

The screen 1302 is a booklet copying function main screen. The main screen includes the size and the type 1313 of a currently set sheet, the currently set number of copies 1314, an illustration 1312 indicating the content of the booklet copying function, and a print settings button 1308 for displaying a screen where the setting values can be set. The print settings button 1308 is operated, whereby the settings of the density and the print quality in addition to the sheet and the number of copies can be changed. However, a layout setting such as 2-in-1 or 4-in-1 cannot be made. In the present exemplary embodiment, one-sided printing for printing image data generated by executing a reading process once on one side of a sheet is set. If a start button is operated in the state where the screen 1302 is displayed, a screen 1303 is displayed.

The screen 1303 is a “now reading” screen displayed in a case where a reading process on a first document is being executed. The screen 1303 displays information indicating that the reading process on the document is being executed, information indicating in which of color and monochrome image processing is being executed, and a bar indicating that the reading process is being executed. If the reading process on the first document is completed, a screen 1304 is displayed.

The screen 1304 is a second document setting guide screen. The second document setting guide screen refers to a screen indicating a method for, in a double-page spread document to be subjected to a reading process in a booklet document, setting a second document (a second half surface) to be subjected to the reading process after a first document (a first half surface) subjected to the reading process first. The screen 1304 also includes an illustration 1311 indicating that the second document is set on the document platen 408 in the orientation in which the booklet document is rotated by 180 degrees in the horizontal direction based on the orientation of the first document set on the document platen 408. The screen 1304 also includes a “print this way” button 1309 for giving an instruction to start the execution of a printing process on the first document of the booklet document by skipping the reading of the second document of the booklet document. The “print this way” button 1309 is operated, whereby the reading process on the second document can be skipped in a case where the printing process on one side (the first document) is to be executed and the printing process is not to be executed on the other side (the second document). The screen 1304 also includes a “start reading” button 1310 for giving an instruction to execute the reading process on the second document of the booklet document and then start the execution of the printing process on the first and second documents. If the button 1309 or 1310 is operated, a screen 1305 is displayed.

The screen 1305 is a “now copying” screen displayed in a case where at least one of the printing process on the first document and the printing process (the copy function) and the reading process on the second document are being executed. The screen 1305 includes information indicating that the copy function is being executed, and information indicating in which of color and monochrome image processing is being executed. The screen 1305 also includes information indicating the remaining number of copies to be printed, a bar indicating that the reading process is being executed, and information indicating the remaining amount of ink in the MFP 100. If the function that is being executed is completed, the screen 1301 is displayed.

With reference to FIGS. 12 and 13, the flowchart for executing the control process for controlling the booklet copying function is described.

First, in step S1201, the CPU 101 displays the first document setting guide screen for setting a first half surface of a booklet document in a double-page spread state on the document platen 408 of the MFP 400 (the screen 1301 in FIG. 13).

Next, in step S1202, the CPU 101 determines whether an operation on the OK button 1306 in FIG. 13 is detected. If it is determined that the operation on the OK button 1306 is detected (YES in step S1202), the processing proceeds to step S1203. If it is determined that the operation on the OK button 1306 is not detected (NO in step S1202), the CPU 101 repeats the process of step S1202.

In step S1203, the CPU 101 displays the booklet copying function main screen (the screen 1302 in FIG. 13).

In step S1204, the CPU 101 determines whether an operation on a start button is detected. The start button refers to the color start button 205 or the monochrome start button 206. If it is determined that the operation on the start button is detected (YES in step S1204), the processing proceeds to step S1205. If it is determined that the operation on the start button is not detected (NO in step S1204), the CPU 101 repeats the process of step S1204.

Then, in step S1205, the CPU 101 executes a reading process on the first document of the booklet document set on the document platen 408 and displays the “now reading” screen (the screen 1303 in FIG. 13). If it is determined that the color start button 205 is operated, the CPU 101 executes a reading process for reading the document in color. If it is determined that the monochrome start button 206 is operated, the CPU 101 executes a reading process for reading the document in monochrome.

In step S1206, the CPU 101 displays the second document setting guide screen (the screen 1304 in FIG. 13).

Next, in step S1207, the CPU 101 determines whether an operation on the “print this way” button 1309 in FIG. 13 is detected. If it is determined that the operation on the “print this way” button 1309 is detected (YES in step S1207), the processing proceeds to step S1209. If it is determined that the operation on the “print this way” button 1309 is not detected (NO in step S1207), the processing proceeds to step S1208.

In step S1209, the CPU 101 executes a printing process for printing image data generated by executing the reading process on the first document on a sheet (without executing the reading process on a second document of the booklet document). Then, the CPU 101 displays the “now copying” screen (the screen 1305 in FIG. 13).

If the execution of the copying is completed, the processing returns to step S1201. In step S1201, the CPU 101 displays the first document setting guide screen (the screen 1301 in FIG. 13).

On the other hand, in step S1208, the CPU 101 determines whether an operation on the “start reading” button 1310 in FIG. 13 is detected. If it is determined that the operation on the “start reading” button 1310 is detected (YES in step S1208), the processing proceeds to step S1210. If it is determined that the operation on the “start reading” button 1310 is not detected (NO in step S1208), the processing returns to step S1207.

In step S1210, the CPU 101 executes the reading process on the second document of the booklet document set on the document platen 408 in step S1205 and displays a “now reading” screen (the screen 1305 in FIG. 13).

In step S1211, the CPU 101 prints first image data generated by executing the reading process on the first document on a first sheet.

In step S1212, the CPU 101 prints second image data generated by executing the reading process on the second document on a second sheet (a sheet different from the first sheet). In the printing process for printing the second image data on the second sheet, the CPU 101 executes a control process for performing control so that the orientation of the first image data generated by executing the reading process relative to the sheet discharge direction of the first sheet on which the first image data is printed and the orientation of the second image data generated by executing the reading process relative to the sheet discharge direction of the second sheet on which the second image data is printed are similar orientations. Specifically, the CPU 101 executes the process of printing the second image data obtained in the execution of the reading process on the second sheet by executing a rotation process for rotating the second image data by 180 degrees in the horizontal direction so that the orientation of the first image data and the orientation of the second image data are the same orientation relative to the sheet discharge directions of the sheets.

If the process of step S1212 is completed, the processing returns to step S1201. In step S1201, the CPU 101 displays the first document setting guide screen (the screen 1301 in FIG. 13). That is, if the CPU 101 displays the screen 1305 in FIG. 13 and at least one of the printing process on the first document and the reading process and the printing process (the copy function) on the second document are completed, the CPU 101 displays the screen 1301 in FIG. 13.

The “now reading” screen (the screen 1305 in FIG. 13) continues to be displayed until at least one of the printing process on the first document and the reading process and the printing process (the copy function) on the second document are completed. That is, in steps S1210 to S1212, the CPU 101 displays the “now reading” screen (the screen 1305 in FIG. 13).

In step S1212, the CPU 101 executes the process of printing the second image data obtained in the execution of the reading process on the second sheet by rotating the second image data by 180 degrees in the horizontal direction so that the orientation of the first image data and the orientation of the second image data are the same orientation relative to the sheet discharge directions of the sheets. However, the CPU 101 may perform the process of printing the first image data obtained in the execution of the reading process on the first sheet by rotating the first image data by 180 degrees in the horizontal direction, and execute the process of printing the second image data obtained in the execution of the reading process on the second sheet without rotating the second image data by 180 degrees in the horizontal direction, thereby aligning the orientation of the first image data relative to the sheet discharge direction of the sheet and the orientation of the second image data relative to the sheet discharge direction of the sheet.

A rotation process on image data may not be executed after the execution of a reading process on the image data and immediately before the execution of a printing process on the image data, but the rotation process on the image data may be executed immediately after the execution of the reading process on the image data.

In a case where the copy function is executed on left and right pages of a booklet document as printing targets, the MFP 100 according to the above exemplary embodiment executes a control process for performing control so that the orientation of image data of the left page relative to the sheet discharge direction in a case where a sheet on which the left page is printed is discharged and the orientation of image data of the right page relative to the sheet discharge direction of a sheet on which the right page is printed are similar orientations. Further, the MFP 100 displays a method for indicating the placement of the respective pages of the booklet document on the document platen 408 (in which orientation the document is to be placed relative to the document platen 408) according to the control process.

Consequently, it is possible to reduce a decrease in usability due to the occurrence of the work of aligning the orientations of a plurality of sheets as printing results. Further, in a case where a page on the side where a reading process is to be executed is set on the document platen 408, a page on the side where the reading process is not to be executed does not interfere with the document platen cover 403 of the MFP 100. This reduces an inability to set the document at an appropriate position on the document platen 408.

Although in the above exemplary embodiment, the booklet copying function to which the above control method is applied, the above control method may be applied to a booklet scanning function.

The booklet scanning function refers to the function of saving image data generated by the MFP 100 executing a reading process, or of specifying a predetermined destination and transmitting the image data. Specifically, the MFP 100 transmits the image data via the communication control unit 110 or the USB function control unit 115 in FIG. 1 to an external host apparatus (not illustrated) with which the MFP 100 can communicate using a network or a USB cable, and saves the image data in a recording unit in the host apparatus. Alternatively, the MFP 100 saves the image data in a recording unit (not illustrated) such as a USB memory connected to the MFP 100 via the USB host control unit 116 in FIG. 1.

In the case of the booklet scanning function to which the above control method is applied, the contents of the figures used to describe the booklet copying function are replaced as follows.

In FIG. 10, “is copy menu selected?” in step S1002 is replaced with “is scan menu selected?”. “Display copy menu screen” in step S1003 is replaced with “display scan menu screen”. “Is booklet copying selected?” in step S1004 is replaced with “is booklet scanning selected?”. Similarly, “transition to first document setting guide screen for booklet copying” in step S1007 is replaced with “transition to first document setting guide screen for booklet scanning”.

In FIG. 12, “display booklet copying main screen” in step S1203 is replaced with “display booklet scanning main screen”. ‘Is “print this way” button operated?’ in step S1207 is replaced with ‘is “scan this way” button operated?’. “Print read image of first half surface” in steps S1209 and S1211 is replaced with “save read image of first half surface”. “Print read image of second half surface (print image by aligning orientations relative to sheet discharge directions)” in step S1212 is replaced with “save read image of second half surface (save image by aligning orientations)”.

In FIG. 13, the “print settings” button 1308 is replaced with a “scan settings” button 1308. The “print this way” button 1309 is replaced with a “scan this way” button 1309. The screen 1305 including “now copying” is replaced with a screen 1305 including “now saving”.

The booklet scanning function to which the above control method is applied is executed, thereby executing control to save image data saved by executing a reading process on a first document (a first half surface) of a booklet document and image data saved by executing the reading process on a second document (a second half surface) of the booklet document so that the orientations of the pieces of image data are similar orientations. This eliminates the need for the work in which due to the difference between the orientation of saved first image data and the orientation of saved second image data, the user changes the orientation of either one of the pieces of image data using a rotation process function as one of methods for editing image data. Thus, it is possible to improve usability.

In the first exemplary embodiment, a form has been described in which, in a case where a left page and a right page (a first document and a second document) of a booklet document in a double-page spread state are subjected to one-sided printing on respective two sheets, the printing orientations of pieces of image data relative to the sheet discharge directions are aligned.

In the second exemplary embodiment, a form is described in which also in a case where two-sided printing is set and executed in the booklet copying function, the printing orientations of pieces of image data relative to the sheet discharge direction are aligned. Components and processes that are not mentioned in the following description are equivalent to those in the first exemplary embodiment, and therefore are not described.

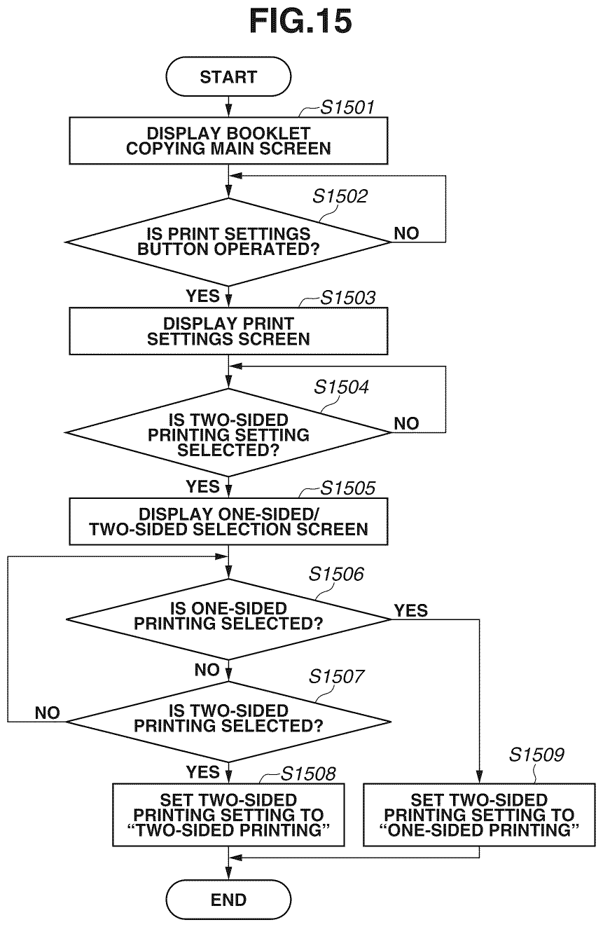

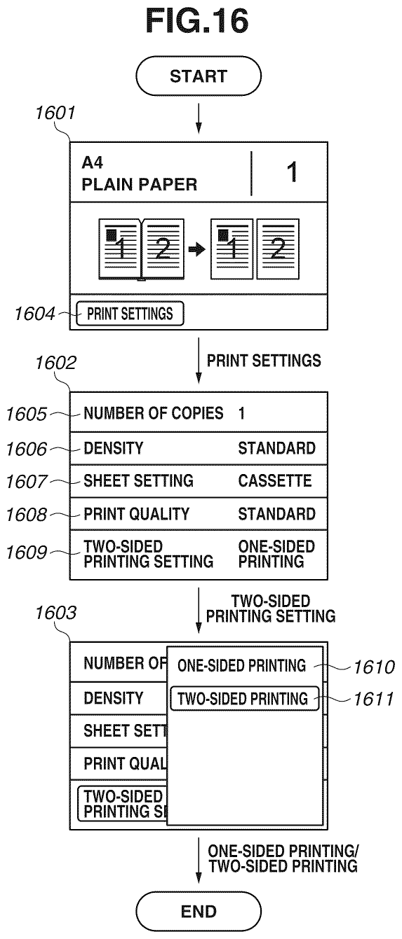

FIG. 15 is a flowchart illustrating a two-sided printing setting in the booklet copying function. The processing of this flowchart is started based on the giving of a display instruction to display the booklet copying function main screen illustrated in a screen 1601 in FIG. 16 (the screen 1302 in FIG. 13) (an operation on the OK button 1306 on the screen 1301 in FIG. 13).

FIG. 16 is a diagram illustrating the transition of screens in a case where the two-sided printing setting in the booklet copying function is made. A screen 1601 is a screen similar to the screen 1302 in FIG. 13. If an operation on a print settings button 1604 included in the screen 1601 is performed, a print settings screen 1602 is displayed. The print settings screen 1602 includes a number-of-copies setting 1605, a copy density setting 1606, a sheet setting 1607, a print quality setting 1608, and a two-sided printing setting 1609. If each setting item is operated, the setting value of the setting item can be set, and for example, the currently set setting value can also be changed. The two-sided printing setting 1609 is a setting item for setting whether to execute two-sided printing or execute one-sided printing on a sheet. If an operation on the two-sided printing setting 1609 is performed, a selection screen 1603 where one-sided printing 1610 or two-sided printing 1611 can be selected as the setting value is displayed.

With reference to FIGS. 15 and 16, an operation on the two-sided printing setting in the booklet copying function is described below.

First, in step S1501, the CPU 101 displays the booklet copying function main screen 1601 in FIG. 16.

In step S1502, the CPU 101 determines whether an operation on the print settings button 1604 in FIG. 16 is detected. If it is determined that the operation on the print settings button 1604 is detected (YES in step S1502), the processing proceeds to step S1503. If it is determined that the operation on the print settings button 1604 is not detected (NO in step S1502), the CPU 101 repeats the process of step S1502.

In step S1503, the CPU 101 displays the print settings screen illustrated in the screen 1602 in FIG. 16.

In step S1504, the CPU 101 determines whether an operation on the “two-sided printing setting” item is detected. If it is determined that the operation on the “two-sided printing setting” item is detected (YES in step S1504), the processing proceeds to step S1505. If it is determined that the operation on the “two-sided printing setting” item is not detected (NO in step S1504), the CPU 101 repeats the process of step S1505.

In step S1505, the CPU 101 displays the selection screen 1603 in FIG. 16.

In step S1506, the CPU 101 determines whether the selection of one-sided printing is detected. If it is determined that the selection of one-sided printing is detected (YES in step S1506), the processing proceeds to step S1509. If it is determined that the selection of one-sided printing is not detected (NO in step S1506), the processing proceeds to step S1507.

In step S1507, the CPU 101 determines whether the selection of two-sided printing is detected. If it is determined that the selection of two-sided printing is detected (YES in step S1507), the processing proceeds to step S1508. If it is determined that the selection of two-sided printing is not detected (NO in step S1507), the processing returns to step S1506.

In step S1508, the CPU 101 sets the two-sided printing setting 1609 to “two-sided printing”, and the processing of this flowchart ends.

In step S1509, the CPU 101 sets the two-sided printing setting 1609 to “one-sided printing”, and the processing of this flowchart ends.

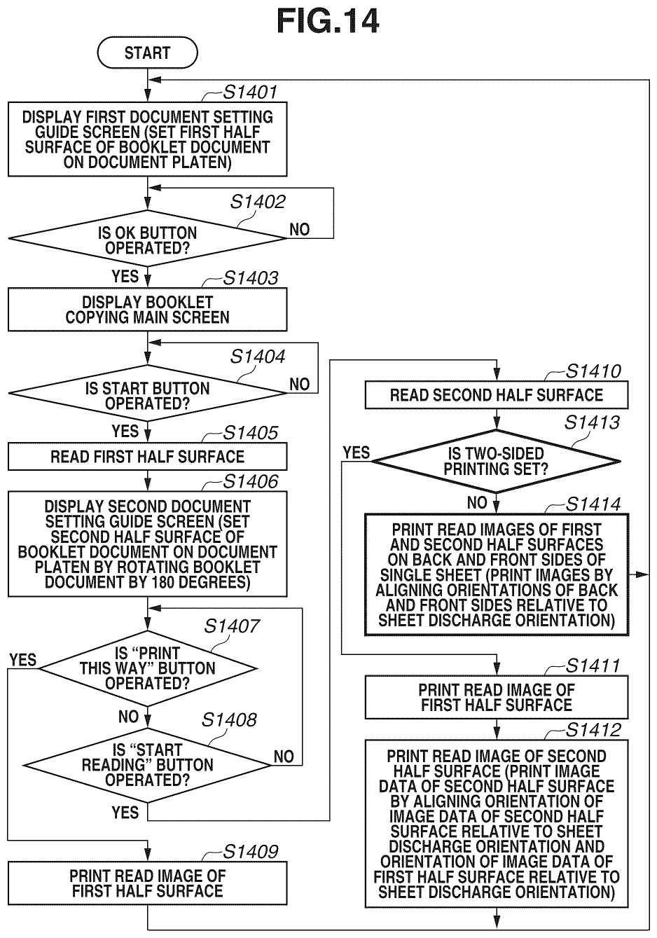

FIG. 14 is a flowchart illustrating a control process for controlling the booklet copying function according to the present exemplary embodiment.

The processing of this flowchart is started based on the detection of the operation on the OK button 1110 in step S1006 in FIG. 10.

The processes of steps S1401 to S1410 and S1411 to S1412 in FIG. 14 are similar to those of steps S1201 to S1210 and S1211 to S1212, respectively, in FIG. 12, and therefore are not described.

In step S1413, the CPU 101 determines whether two-sided printing is set as the setting value of the two-sided printing setting 1609. If it is determined that two-sided printing is set as the setting value of the two-sided printing setting 1609 (YES in step S1413), the processing proceeds to step S1414. If it is determined that two-sided printing is not set (one-sided printing is set) as the setting value of the two-sided printing setting 1609 (NO in step S1413), the processing proceeds to step S1411.

In step S1414, the CPU 101 prints second image data generated by executing the reading process on the second document on a back side of a first sheet (the same sheet as a sheet on a front side of which first image data is printed). In the printing process for printing the second image data on the first sheet, the CPU 101 executes a control process for performing control so that the orientation of the first image data generated by executing the reading process relative to the sheet discharge direction of the first sheet on which the first image data is printed and the orientation of the second image data generated by executing the reading process relative to the sheet discharge direction of the first sheet on which the second image data is printed are similar orientations. Specifically, the CPU 101 executes the process of printing the second image data obtained in the execution of the reading process on the first sheet by executing a rotation process for rotating the second image data by 180 degrees in the horizontal direction so that the orientation of the first image data and the orientation of the second image data are the same orientation relative to the sheet discharge direction of the sheet. Then, the processing returns to step S1401.

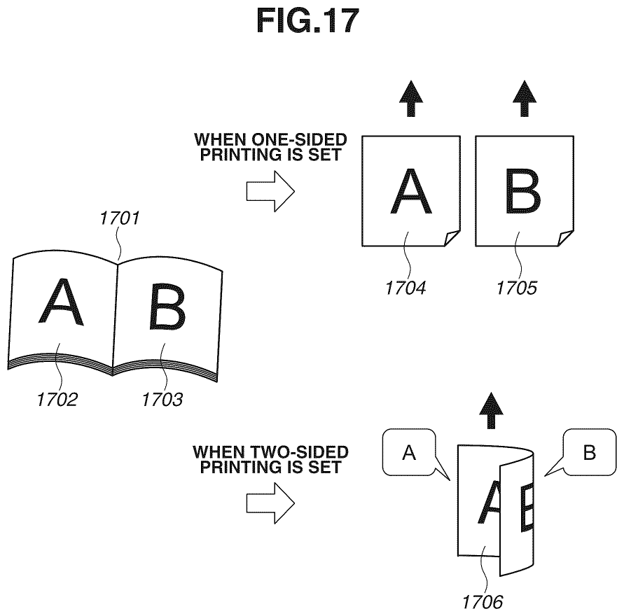

FIG. 17 is a diagram illustrating printing results in a case where the booklet copying function in which two-sided printing is set is executed. FIG. 17 illustrates a booklet document 1701 in a double-page spread state, image data “A” of a left page 1702 in printing target pages of the booklet document 1701, and image data “B” of a right page 1703 in the printing target pages of the booklet document 1701. FIG. 17 also illustrates a printing result 1704 of the left page 1702 of the document 1701 in a case where the booklet copying function in which one-sided printing is set is executed, and it is indicated that a sheet is discharged in the orientation of an arrow. Similarly, FIG. 17 illustrates a printing result 1705 of the right page 1703 of the document 1701 in a case where the booklet copying function in which one-sided printing is set is executed, and it is indicated that a sheet is discharged in the orientation of an arrow. On the other hand, FIG. 17 illustrates a printing result 1706 of the printing of the left page 1702 of the document 1701 on a front side (one side) of a sheet and the printing of the right page 1703 of the document 1701 on a back side (the other side) of the sheet in a case where the booklet copying function in which two-sided printing is set is executed, and it is indicated that the sheet is discharged in the orientation of an arrow.

Thus, in the above exemplary embodiment, also in a case where two-sided printing is set and executed in the booklet copying function, printing results in which the printing orientations of a plurality of pieces of image data relative to the sheet discharge direction are similar orientations are obtained.

In the first and second exemplary embodiments, the MFP 100 is on the premise that in a booklet document in a double-page spread state, a first half surface to be read first is a left half surface, and a second half surface to be read next is a right half surface. That is, a first document setting guide screen for reading a left half surface and a second document setting guide screen for reading a right half surface are displayed on the premise of a left-bound booklet document. However, in a case where a booklet copying function for a right-bound booklet document is executed, there is a possibility that a right-bound booklet document cannot be set as indicated by the first document setting guide screen for reading a left half surface and the second document setting guide screen for reading a right half surface, and usability decreases.

Accordingly, in a third exemplary embodiment, a form is described in which document setting guides corresponding to not only a left-bound booklet document but also a right-bound booklet document can be provided.

Components and processes that are not mentioned in the following description are equivalent to those in the first exemplary embodiment, and therefore are not described.

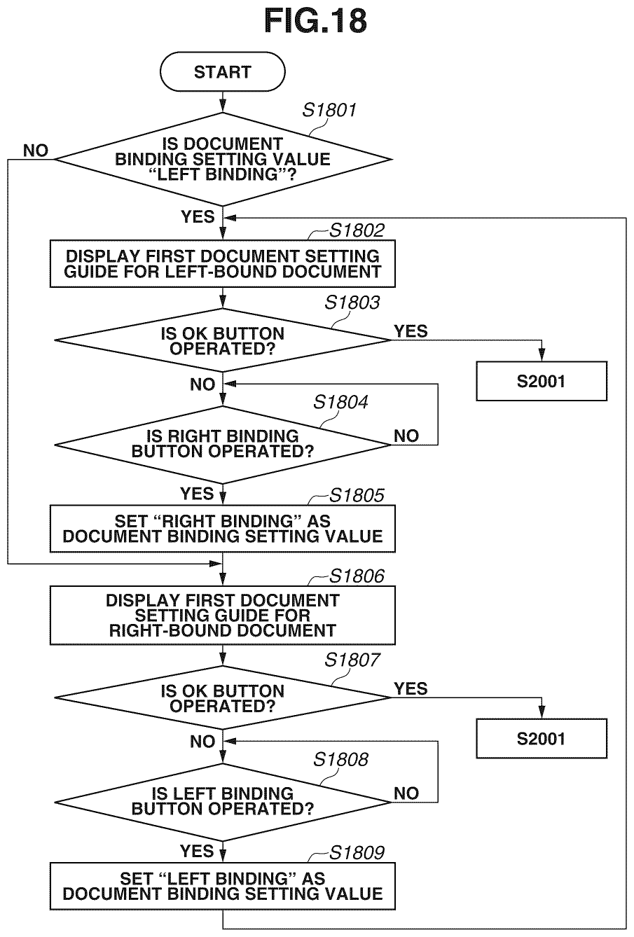

FIG. 18 is a flowchart illustrating the process of setting a document binding setting value of the booklet copying function and the process of switching the display of first document setting guide screens based on the manner of binding a document according to the present exemplary embodiment.

The processing of this flowchart is started based on the detection of the operation on the OK button 1110 in step S1006 in FIG. 10.

First, in step S1801 in FIG. 18, the CPU 101 determines whether a document binding setting value is a value indicating “left binding” or a value indicating “right binding”. The document binding setting value is a value held in the non-volatile memory 118 in FIG. 1, and either 1 as the value indicating “left binding” or 2 as the value indicating “right binding” is held (the initial value is 1 indicating “left binding”). The CPU 101 updates the value and confirms the value, where necessary. If it is determined that the document binding setting value is the value indicating “left binding” (YES in step S1801), the processing proceeds to step S1802. If it is determined that the document binding setting value is not the value indicating “left binding” (NO in step S1801), the processing proceeds to step S1806.

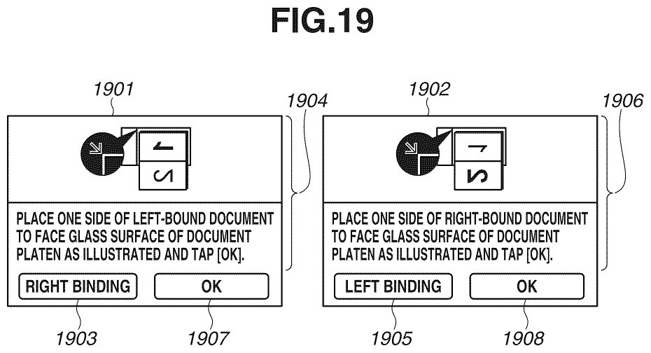

In step S1802, the CPU 101 displays a first document setting guide screen for a left-bound document. A screen 1901 in FIG. 19 illustrates a first document setting guide screen in a case where the document binding setting value is “left binding” (a first setting screen), and includes a right binding button 1903, an illustration and descriptive text 1904 indicating a method for setting a left-bound document, and an OK button 1907.

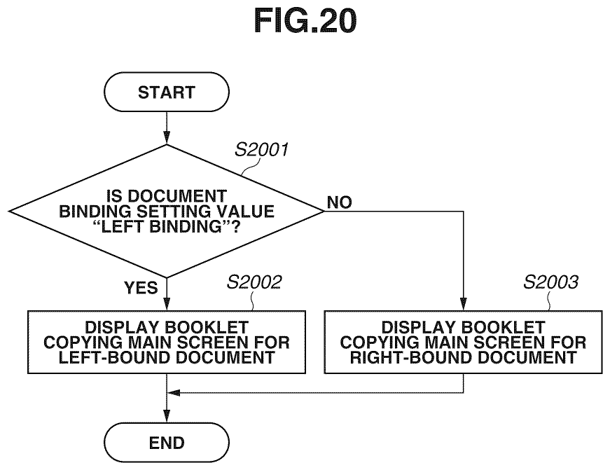

In step S1803, the CPU 101 determines whether the OK button 1907 is operated. If it is determined that the OK button 1907 is operated (YES in step S1803), the processing proceeds to step S2001 in FIG. 20. If it is determined that the OK button 1907 is not operated (NO in step S1803), the processing proceeds to step S1804.

Next, in step S1804, the CPU 101 determines whether the right binding button 1903 is operated. If it is determined that the right binding button 1903 is operated (YES in step S1804), the processing proceeds to step S1805. If it is determined that the right binding button 1903 is not operated (NO in step S1804), the CPU 101 repeats the process of step S1804.

In step S1805, the CPU 101 sets “right binding” as the document binding setting value.

In step S1806, the CPU 101 displays a first document setting guide screen for a right-bound document (a second setting screen). A screen 1902 in FIG. 19 illustrates a first document setting guide screen in a case where the document binding setting value is “right binding”, and includes a left binding button 1905, an illustration and descriptive text 1906 indicating a method for setting a right-bound document, and an OK button 1908.

In step S1807, the CPU 101 determines whether the OK button 1908 is operated. If it is determined that the OK button 1908 is operated (YES in step S1807), the processing proceeds to step S2001 in FIG. 20. If it is determined that the OK button 1908 is not operated (NO in step S1807), the processing proceeds to step S1808.

Next, in step S1808, the CPU 101 determines whether the left binding button 1905 is operated. If it is determined that the left binding button 1905 is operated (YES in step S1808), the processing proceeds to step S1809. If it is determined that the left binding button 1905 is not operated (NO in step S1808), the CPU 101 repeats the process of step S1808.

In step S1809, the CPU 101 sets “left binding” as the document binding setting value, and the processing returns to step S1802.

By the control in FIG. 18, in a case where a first document setting guide screen is displayed, the CPU 101 can display the first document setting guide screen by appropriately switching a document setting guide screen for left binding and a document setting guide screen for right binding based on the setting value of the document binding setting.

FIG. 20 is a flowchart illustrating the process of switching the display of booklet copying main screens according to the present exemplary embodiment. This flowchart is started based on the determination of YES in step S1803 or S1807 in FIG. 18 (the detection of the operation on the OK button 1907 or 1908).

First, in step S2001 in FIG. 20, the CPU 101 determines whether “left binding” is set as the document binding setting value. If it is determined that “left binding” is set as the document binding setting value (YES in step S2001), the processing proceeds to step S2002. If it is determined that “left binding” is not set as the document binding setting value (NO in step S2001), the processing proceeds to step S2003.

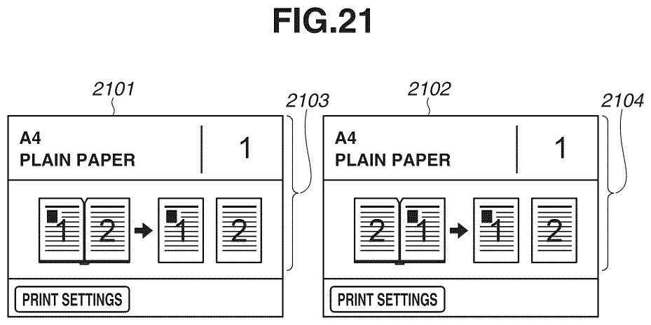

In step S2002, the CPU 101 displays a booklet copying main screen for a left-bound document. A screen 2101 in FIG. 21 is a booklet copying main screen in a case where the document binding setting value is “left binding”, and includes an illustration 2103 indicating a left-bound booklet document and the printing result of the left-bound booklet document. Then, the CPU 101 executes processes similar to those of steps S1204 and S1205 in FIG. 12.

On the other hand, in step S2003, the CPU 101 displays a booklet copying main screen for a right-bound document. A screen 2102 in FIG. 21 is a booklet copying main screen in a case where the document binding setting value is “right binding”, and includes an illustration 2104 indicating a right-bound booklet document and the printing result of the right-bound booklet document. Then, the CPU 101 executes processes similar to those of steps S1204 and S1205 in FIG. 12.

By the control in FIG. 20, also in a case where a booklet copying main screen is displayed, the CPU 101 can display the booklet copying main screen by appropriately switching a screen including an illustration for left binding and a screen including an illustration for right binding based on the setting value of the document binding setting.

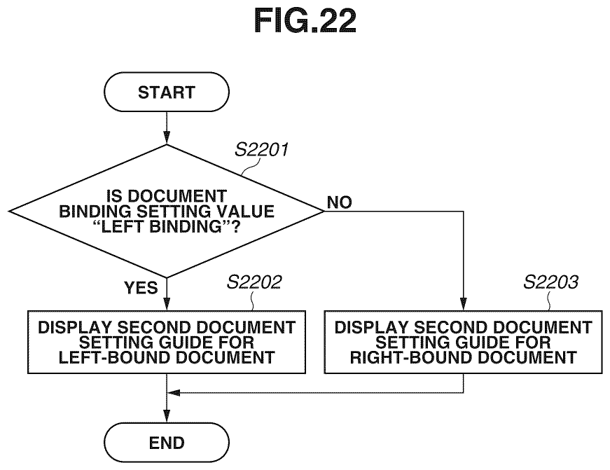

FIG. 22 is a flowchart illustrating the process of switching the display of second document setting guide screens according to the present exemplary embodiment. The processing of this flowchart is started based on the completion of the reading process on the first document by the CPU 101 in the process of step S1205 in FIG. 12 executed after step S2002 or S2003 in FIG. 20.

First, in step S2201, the CPU 101 determines whether “left binding” is set as the document binding setting value. If it is determined that “left binding” is set as the document binding setting value (YES in step S2201), the processing proceeds to step S2202. If it is determined that “left binding” is not set as the document binding setting value (NO in step S2201), the processing proceeds to step S2203.

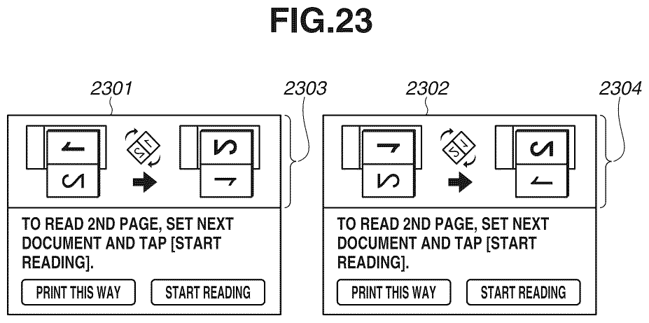

In step S2202, the CPU 101 displays a second document setting guide screen for a left-bound document. A screen 2301 in FIG. 23 is a second document setting guide screen in a case where the document binding setting value is “left binding”, and includes an illustration 2303 indicating that a left-bound booklet document is set on the document platen 408 by rotating the left-bound booklet document by 180 degrees in the horizontal direction. Then, the CPU 101 executes processes similar to those of steps S1207 to S1212 in FIG. 12.

On the other hand, in step S2203, the CPU 101 displays a second document setting guide screen for a right-bound document. A screen 2302 in FIG. 23 is a second document setting guide screen in a case where the document binding setting value is “right binding”, and includes an illustration 2304 indicating that a right-bound booklet document is set on the document platen 408 by rotating the right-bound booklet document by 180 degrees in the horizontal direction. Then, the CPU 101 executes processes similar to those of steps S1207 to S1212 in FIG. 12.

By the control in FIG. 22, in a case where a second document setting guide screen is displayed, the CPU 101 can display the second document setting guide screen by appropriately switching a document setting guide screen for left binding and a document setting guide screen for right binding based on the setting value of the document binding setting.

In the above exemplary embodiment, a form has been described in which a document binding setting value based on the manner of binding a booklet document can be set, and the display of document setting guide screens based on the manner of binding a booklet document can be switched based on the document binding setting value. Consequently, no matter which of a right-bound document and a left-bound document the manner of binding a booklet document corresponds to, it is possible to provide an appropriate document setting guide screen based on the manner of binding each document.

### Other Exemplary Embodiments

The above-described exemplary embodiments can also be realized by executing the following processing. Specifically, the processing is processing in which software (program) for implementing the functions of the above-described exemplary embodiments is supplied to a system or an apparatus via a network or various storage media, and a computer (a CPU, a micro processing unit (MPU), or the like) of the system or the apparatus reads and executes the program. The program may be executed by a single computer or may be executed by a plurality of computers in conjunction with each other. Further, it is not necessary to implement all of the above-described processing by software, and a part or all of the processing may be implemented by hardware such as an application specific integrated circuit (ASIC). Furthermore, the CPU is not limited to a single CPU that performs all the processing, and a plurality of CPUs may perform the processing in cooperation with each other as appropriate.

Furthermore, the functions of the above-described exemplary embodiments may be implemented not only by executing program code read by the computer, but also by causing an OS or the like running on the computer to perform part or all of the actual processing based on instructions from the program code.

According to the present disclosure, it is possible to improve usability in a case where a document is read in an image processing apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-107514, filed Jul. 3, 2024, which is hereby incorporated by reference herein in its entirety.

What is claimed is:

1. An image processing apparatus comprising:
a reading unit configured to execute a reading process for reading a document placed on a document platen;
a printing unit configured to print image data obtained by the reading unit executing the reading process;
a display control unit configured to display a screen indicating a method for placing a first document on the document platen, and a screen indicating a method for placing a second document on the document platen and for placing the second document on the document platen in an orientation different from an orientation in which the first document is placed on the document platen; and
a control unit configured to execute a control process for performing control so that an orientation of first image data generated by the reading unit executing the reading process on the first document relative to a sheet discharge direction of a first sheet on which the first image data is printed by the printing unit, and an orientation of second image data generated by the reading unit executing the reading process on the second document relative to a sheet discharge direction of a second sheet on which the second image data is printed by the printing unit are similar orientations.

2. The image processing apparatus according to claim 1, wherein the first image data is printed on one side of the first sheet, and the second image data is printed on one side of the second sheet different from the first sheet.

3. The image processing apparatus according to claim 1, wherein in a case where a setting is made so that the first image data and the second image data are printed on one side of a single sheet, the control unit does not execute the control process.

4. The image processing apparatus according to claim 1, wherein in a case where a setting is made so that the first image data and the second image data are printed on respective sides of a single sheet, the control unit executes the control process.

5. The image processing apparatus according to claim 1, wherein the first image data and the second image data are different from each other.

6. The image processing apparatus according to claim 1, wherein the orientation different from the orientation in which the first document is placed on the document platen is an orientation obtained by rotating the first document by 180 degrees based on the orientation of the first document in a horizontal direction.

7. The image processing apparatus according to claim 1, wherein in a case where a document including the first and second documents is a left-bound document, the display control unit displays a screen indicating a method for placing the left-bound document on the document platen, and in a case where the document including the first and second documents is a right-bound document, the display control unit displays a screen indicating a method for placing the right-bound document on the document platen.

8. The image processing apparatus according to claim 1, wherein the display control unit displays a first setting screen on which a setting is made so that a document including the first and second documents is a left-bound document, and a second setting screen on which a setting is made so that the document including the first and second documents is a right-bound document.

9. The image processing apparatus according to claim 8, further comprising a setting unit configured to, on the first setting screen, make the setting so that the document including the first and second documents is a left-bound document based on an operation of indicating that the document including the first and second documents is a left-bound document, and on the second setting screen, make the setting so that the document including the first and second documents is a right-bound document based on an operation of indicating that the document including the first and second documents is a right-bound document.

10. The image processing apparatus according to claim 1, wherein the first and second documents are documents included in a bound booklet.

11. A control method comprising:
executing a reading process for reading a document placed on a document platen;
printing image data obtained by executing the reading process;
displaying a screen indicating a method for placing a first document on the document platen, and a screen indicating a method for placing a second document on the document platen and for placing the second document on the document platen in an orientation different from an orientation in which the first document is placed on the document platen; and
executing a control process for performing control so that an orientation of first image data generated by executing the reading process on the first document relative to a sheet discharge direction of a first sheet on which the first image data is printed, and an orientation of second image data generated by executing the reading process on the second document relative to a sheet discharge direction of a second sheet on which the second image data is printed are similar orientations.

12. A non-transitory computer-readable storage medium storing a program for causing a computer to execute a control method of the image processing apparatus, the method comprising:
executing a reading process for reading a document placed on a document platen;
printing image data obtained by executing the reading process;
displaying a screen indicating a method for placing a first document on the document platen, and a screen indicating a method for placing a second document on the document platen and for placing the second document on the document platen in an orientation different from an orientation in which the first document is placed on the document platen; and
executing a control process for performing control so that an orientation of first image data generated by executing the reading process on the first document relative to a sheet discharge direction of a first sheet on which the first image data is printed, and an orientation of second image data generated by executing the reading process on the second document relative to a sheet discharge direction of a second sheet on which the second image data is printed are similar orientations.
